(19) United States
(12) Patent Application Publication
(10) Pub. No.: US 2011/0060987 A1
(43) Pub. Date: Mar. 10, 2011

(54) TOUCH SCREEN DISPLAY WITH TOUCH OSD AND OSD CONTROL METHOD THEREOF

(75) Inventor: Dun-Chi Huang, Taoyuan (TW)

(73) Assignee: QISDA CORPORATION, Taoyuan (TW)

(21) Appl. No.: 12/876,160

(22) Filed: Sep. 5, 2010

(30) Foreign Application Priority Data
Sep. 9, 2009 (TW) 098130304

(51) Int. Cl. G06F 3/041; G06F 3/01

(52) U.S. Cl. 715/702; 345/173

(57) ABSTRACT

The invention provides a touch screen display with on-screen display (OSD) function and OSD control method thereof. In particular, the touch screen display according to the invention utilizes a touch screen thereof to assist in controlling launch, close and various adjust of the OSD function. Thereby, the touch screen display according to the invention doesn't need any more buttons and encoders utilized in prior arts to control OSD function.

### CROSS-REFERENCE TO RELATED APPLICATION

This utility application claims priority to Taiwan Application Serial Number 098130304, filed Sep. 9, 2009, which is incorporated herein by reference.

### BACKGROUND OF THE INVENTION

1. Field of the Invention

The invention relates to a touch screen display with OSD (on-screen display) function and OSD control method thereof, and more particularly, to a touch screen display using touch screen of its own to control the OSD function and OSD control method thereof.

2. Description of the Prior Art

Common displays have stand-alone type such as TV sets, monitors, digital photo frames, etc.; and also have type of combination with various electronic devices such as digital cameras, lap-top computers, hand-held DVD players, etc. For users to adjust parameters related to video and audio (e.g. brightness, hue, contrast, size, position, vertical/horizontal scan frequency, language selection, and so on), many displays provide OSD functions. A conventional display with OSD function has a plurality of user-operable buttons and knobs disposed on the housing. By operating the buttons and knobs on the hosing of the display, a user can open an OSD menu and adjust the displaying parameters of the display.

However, the buttons and knobs have a noise problem caused by mechanical operation, and cost of the buttons and knob is added to the display. Besides, for operating the buttons and knobs, clear graphic symbols corresponding to the functions of the buttons and knobs need to be printed on the panel of the display. Obviously, display with small size has no spare space on its panel for printing the clear graphic symbols corresponding to the functions of the buttons and knobs. In addition, it is evidently inconvenient to control the OSD functions with the buttons and knobs, and the appearance designs of the displays are also limited.

TW Patent application No. 095141399 discloses replacing buttons and knobs of prior arts with a plurality of touch sensors (such as capacitive-type touch sensors) to control the OSD function of a display. However, cost of touch sensors is higher than prior buttons and knobs, and need to include cost of controllers for controlling the plural touch sensors. Besides, in practice, for informing functions of the buttons and knobs, corresponding clear graphic symbols still need to be printed on the panel of the display. Obviously, using touch sensors for controlling the OSD function of the display does not completely resolve problems caused by prior arts.

Along with increasing popularity of touch screen displays with touch screen, there is still no any technology using touch screen to control the OSD function yet. Therefore, a scope of the invention is to provide a touch screen display with OSD function and OSD control method thereof. And particularly, the OSD function according to the invention is controlled by the touch screen of the touch screen display itself. Accordingly, aforesaid problems caused by prior arts of OSD functions can be completely resolved.

### SUMMARY OF THE INVENTION

The touch screen display according to a first preferred embodiment of the invention includes an OSD controller, a display screen, a processor, a touch screen and a touch controller. The OSD controller is used for generating an OSD menu. The processor is electrically connected to the OSD controller and the display screen respectively. The processor is used for receiving the OSD menu from the OSD controller, and outputting the OSD menu to the display screen to display the OSD menu on the display screen. The touch screen is installed on the display screen. The touch screen thereon has a region corresponding to the OSD menu displayed on the display screen. The touch controller is electrically connected to the touch screen and the processor respectively. The touch controller is used for receiving at least one signal generated by the touch screen. The at least one signal is generated in response to at least one external force imposed on the touch screen. The touch controller also interprets the at least one signal into at least one touch position relative to the at least one external force. The processor receives the at least one touch position, judges whether the at least one touch position matches an OSD close command, and if YES, generates the OSD close command and transmits the OSD close command to the OSD controller to close the OSD menu. Furthermore, if the processor judges that the at least one touch position does not match the OSD close command, the processor judges whether the at least one touch position locates within the region, and if YES, generates an OSD instruction according to the at least one touch position and transmits the OSD instruction to the OSD controller.

The touch screen display according to a second preferred embodiment of the invention includes an OSD controller, a display screen, a processor, a touch screen and a touch controller. The OSD controller is used for generating an OSD menu. The processor is electrically connected to the OSD controller and the display screen respectively. The processor is used for receiving the OSD menu from the OSD controller, and outputting the OSD menu to the display screen to display the OSD menu on the display screen. The touch screen is installed on the display screen. The touch screen thereon has a region corresponding to the OSD menu displayed on the display screen. The touch controller is electrically connected to the touch screen and the processor respectively. The touch controller is used for receiving at least one signal generated by the touch screen. The at least one signal is generated in response to at least one external force imposed on the touch screen. The touch controller also interprets the at least one signal into at least one touch position relative to the at least one external force. The OSD controller receives the at least one touch position, judges whether the at least one touch position matches an OSD close command, and if YES, generates the OSD close command to close the OSD menu. Furthermore, if the OSD controller judges that the at least one touch position does not match the OSD close command, the OSD controller judges whether the at least one touch position locates within the region, and if YES, generates an OSD instruction according to the at least one touch position.

The control method according to a third preferred embodiment according to the invention is used for controlling an OSD function of a touch screen display. The touch screen display includes a touch screen and a display screen. The control method according to the invention, firstly, generates at least one signal in response to at least one external force imposed on the touch screen. Then, the control method interprets the at least one signal into at least one touch position relative to the at least one external force. Then, the control method judges if the OSD function is turned on. If the OSD function is judged turned on, the control method then judges if the at least one touch position matches an OSD close command, and if YES, generates the OSD close command to close the OSD function. If the at least one touch position does not match the OSD close command by judgment, the control method further judges if the at least one touch position locates within a region on the touch screen, where the region corresponds to an OSD menu displayed on the display screen and relative to the turned-on OSD function. IF the at least one touch position locates within the region on the touch screen by judgment, the control method generates an OSD instruction according to the at least one touch position.

The advantage and spirit of the invention may be understood by the following recitations together with the appended drawings.

### BRIEF DESCRIPTION OF THE APPENDED DRAWINGS

FIG. 1 is a schematic diagram illustrating a touch screen display according to a first preferred embodiment of the invention.

FIG. 2 is a function block diagram schematically illustrating the architecture of the touch screen display according to the first preferred embodiment of the invention.

FIG. 3 is a function block diagram schematically illustrating the architecture of the touch screen display according to the second preferred embodiment of the invention.

FIG. 4 is a flow chart illustrating the control method for controlling OSD function of the touch screen display according to the third preferred embodiment of the invention.

### DETAILED DESCRIPTION OF THE INVENTION

The invention provides a touch screen display with OSD function and OSD control method thereof, which utilizes touch screen thereof to control OSD function. Thereby, the touch screen display can resolve the problems caused by using buttons, knobs or touch-sensing components for controlling the OSD function. With following detailed explanations of the preferred embodiments of the invention, the features, spirits, advantages, and feasibility of the invention will be hopefully well described.

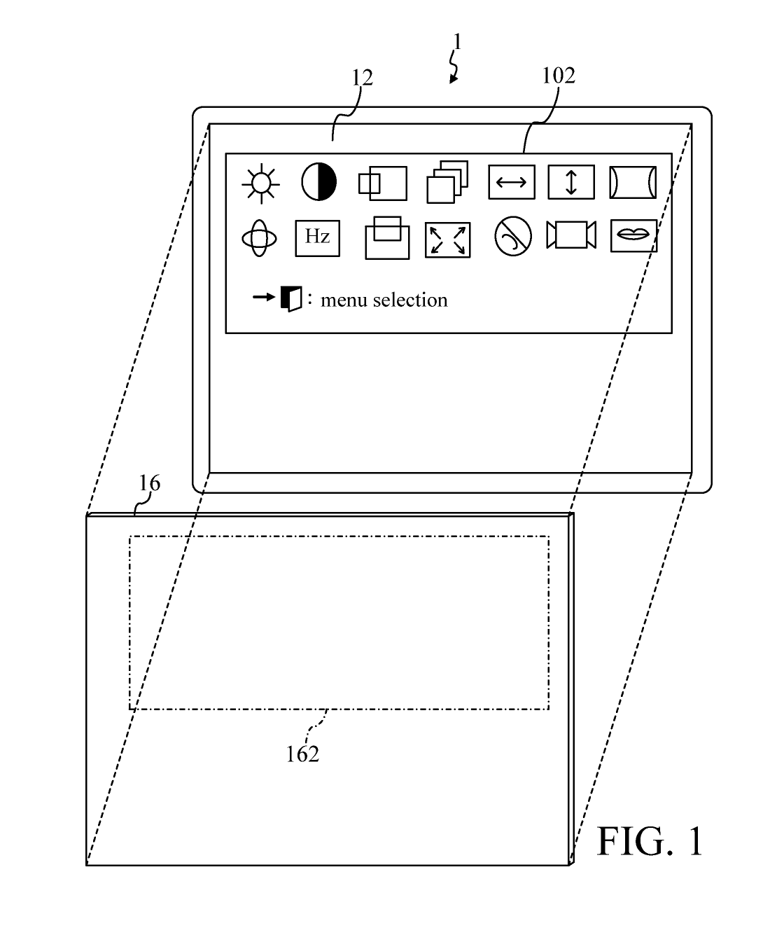

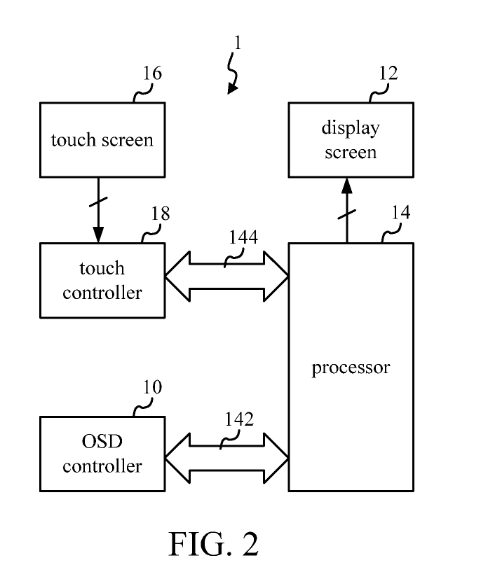

Please refer to FIG. 1 and FIG. 2. FIG. 1 is a schematic diagram illustrating a touch screen display 1 according to a first preferred embodiment of the invention. FIG. 1 also deliberately illustrates a touch screen 16 installed on a display screen 12. FIG. 2 is a function block diagram schematically illustrating the necessary components of the touch screen display 1 according to the first preferred embodiment of the invention.

As shown in FIG. 2, the touch screen display 1 according to the first preferred embodiment of the invention includes an OSD controller 10, a display screen 12, a processor 14, a touch screen 16 and a touch controller 18.

As well as shown in FIG. 2, the processor 14 communicates with the OSD controller 10 through a bus 142 (such as USB). The processor 14 also communicates with the touch controller 18 through another bus (such as DIV, DSUB, USB, DDCi/Ci, or so on). The processor 14 is electrically connected to the display screen 12. The touch controller 18 is electrically connected to the touch screen 16.

The OSD controller 10 is used for generating an OSD menu 102. The processor 14 is used for receiving the OSD menu 102 from the OSD controller 10 and outputting the OSD menu to the display screen 12 to display the OSD menu 102 on the display screen 12 as shown in FIG. 1.

As well as shown in FIG. 1, the touch screen 16 is installed on the display screen 12. The touch screen 16 thereon has a region 162 corresponding to the OSD menu 102 displayed on the display screen 12. Particularly, the OSD menu 102 displayed on the display screen 12 can be executed as an object, and a user can use the touch screen 16 to drag OSD menu 102 to any position on the display screen 12. Most of the prior arts can only display the OSD menu in a fixed region on the display screen.

The touch controller 18 is used for receiving at least one signal generated by the touch screen 16. The at least one signal is generated in response to at least one external force (e.g. the force of a finger of a user imposed on the touch screen 16) imposed on the touch screen 16. The touch controller 18 also translates the at least one signal into at least one touch position relative to the at least one external force.

The processor 14 receives the at least one touch position translated by the touch controller 18, and then judges whether the at least one touch position matches an OSD close command. For example, a double touch on the touch screen 16 is interpreted as an OSD close command by design. Accordingly, the processor 14 judges whether the at least one touch position is a double touch to judge whether the at least one touch position matches an OSD close command. If the processor 14 judges the at least one touch position matches the OSD close command, then the processor 14 generates the OSD close command and transmits the OSD close command to the OSD controller 10 to close the OSD menu 102.

Similarly, if the OSD menu 102 was originally closed, the processor 14 judges whether the at least one touch position matches an OSD open command, and if YES, generates the OSD open command and transmits the OSD open command to the OSD controller 10 to open the OSD menu 102.

Furthermore, if the processor 14 judges the at least one touch position does not match the OSD close command, then processor 14 judges whether the at least one touch position locates within the region 162, and if YES, generates an OSD instruction (such as increasing brightness, increasing contrast, etc.) according to the at least one touch position and transmits the OSD instruction to the OSD controller 10.

As to another operation method inside the touch screen display 1 according to the first preferred embodiment of the invention, the processor 14 receives the at least one touch position and judges whether the at least one touch position locates within the region 162 first. If the judged result is YES, then the processor 14 generates the OSD instruction according to the at least one touch position and transmits the OSD instruction to the OSD controller 10. If the processor 14 judges the at least one touch position does not locate within the region 162, then the processor 14 judges whether the at least one touch position matches an OSD close command, and if YES, generates the OSD close command and transmits the OSD close command to the OSD controller to close the OSD menu 102.

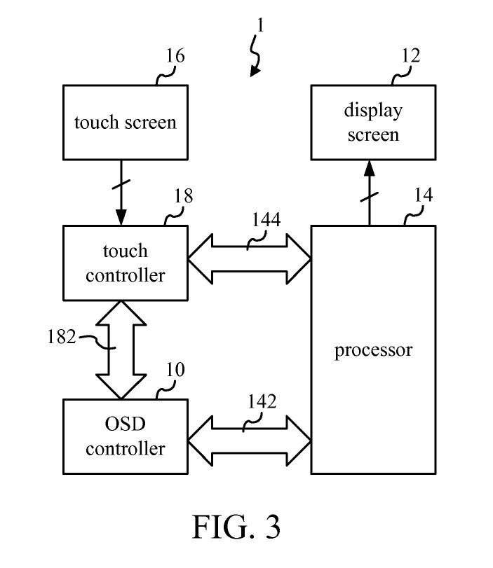

As to the touch screen display 1 according to the second preferred embodiment of the invention, please refer to FIG. 1 and FIG. 3. FIG. 1 is also the schematic diagram illustrating a touch screen display 1 according to the second preferred embodiment of the invention. FIG. 3 is a function block diagram schematically illustrating the necessary components of the touch screen display 1 according to the second preferred embodiment of the invention.

As shown in FIG. 3, the touch screen display 1 according to the second preferred embodiment of the invention also includes an OSD controller 10, a display screen 12, a processor 14, a touch screen 16 and a touch controller 18. The components and buses in FIG. 3 having identical reference numerals as those in FIG. 2 substantially perform the same function as the corresponding components and buses in FIG. 2, which are not described again here. The difference between FIG. 3 and FIG. 2 is that in FIG. 3 the touch controller 18 communicates with the OSD controller 10 through a bus 182 (such as FC, SPI, etc.). Similarly, The OSD controller 10 is used for generating an OSD menu 102. The processor 14 is used for receiving the OSD menu 102 from the OSD controller 10, and outputting the OSD menu 102 to the display screen 12 to display the OSD menu 102 on the display screen 12. The touch screen 16 thereon has a region 162 corresponding to the OSD menu 102 displayed on the display screen 12, as shown in FIG. 1.

It is to be emphasized that according to the second preferred embodiment of the invention, it is not the processor 14 that judges whether the at least one touch position matches one among the OSD close command, the OSD open command and other OSD instructions. The difference from the first preferred embodiment of the invention is that the OSD controller 10 receives the at least one touch position, judges whether the at least one touch position matches an OSD close command, and if YES, generates the OSD close command to close the OSD menu 102.

If the OSD menu 102 was originally closed, then the OSD controller 10 judges whether the at least one touch position matches an OSD open command, and if YES, generates an OSD open command to open the OSD menu 102.

Furthermore, if the OSD controller 10 judges that the at least one touch position does not match the OSD close command, the OSD controller 10 judges whether the at least one touch position locates within the region 162, and if YES, generates an OSD instruction according to the at least one touch position.

In addition, in an embodiment, the touch controller 18 and the OSD controller 10 can be integrated into a single component. Whether the at least one touch position matches one among the OSD close command, the OSD open command and other OSD instructions is judged by a function block in charge of OSD control in the single integrated control component.

As to another operation method inside the touch screen display 1 according to the second preferred embodiment of the invention, the OSD controller 10 receives the at least one touch position and judges whether the at least one touch position locates within the region 162 first. If the judged result is YES, then the OSD controller 10 generates the OSD instruction according to the at least one touch position. If the OSD controller 10 judges the at least one touch position does not locate within the region 162, then the OSD controller 10 judges whether the at least one touch position matches an OSD close command, and if YES, generates the OSD close command to close the OSD menu 102.

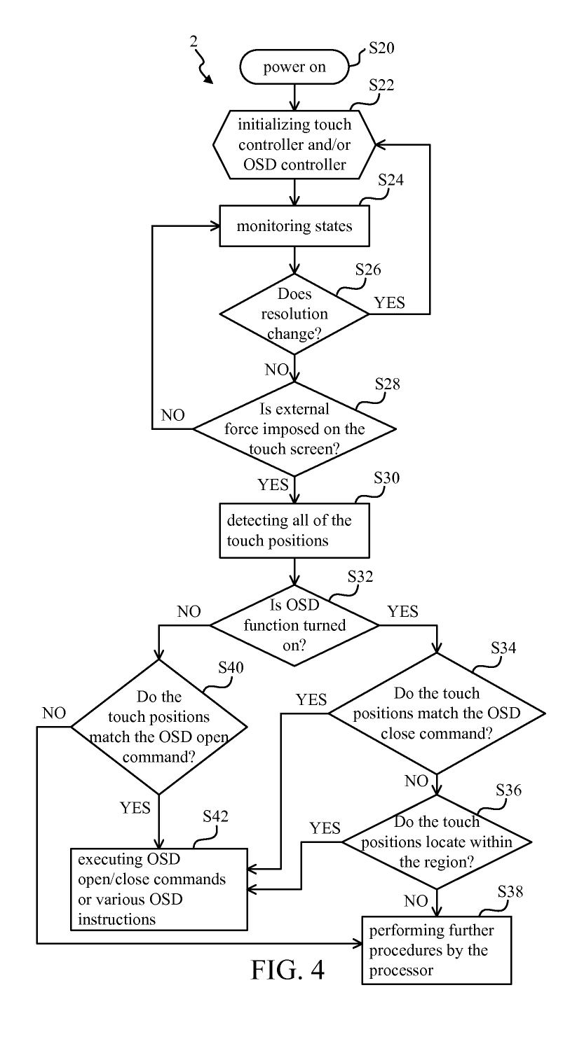

Please refer to FIG. 4. FIG. 4 is a flow chart illustrating the control method 2 according to the third preferred embodiment of the invention. The control method 2 according to the invention is used for controlling an OSD function of a touch screen display. The touch screen display includes an OSD controller, a display screen, a processor, a touch screen, and a touch controller.

As shown in FIG. 4, the control method 2, firstly, performs step S20 to turn the power on. Then, the control method 2 performs step S22 to initialize the touch controller and/or the OSD controller.

After that, the control method 2 performs step S24 to enter the monitoring state for monitoring inputs from the touch controller and inputs from the processor and for querying output data from the touch controller.

Then, the control method 2 performs step S26 to judge whether the resolution changes. If the judged result in step S26 is YES, the control method 2 then performs step S22 to initialize the touch controller and/or the OSD controller.

IF the judged result in step S26 is NO, the control method 2 performs step S28 to judge whether any external force is imposed on the touch screen. If the judged result in step S28 is NO, the control method 2 then performs step S24 to enter the monitoring state.

If the judged result in step S28 is YES, the control method 2 then performs step S30 to detect all of the touch positions, i.e. to generate at least one signal in response to at least one external force imposed on the touch screen, and to interpret the at least one signal into at least one touch position relative to the at least one external force.

After performing step S30, the control method 2 performs step S32 to judge if the OSD function is turned on. If the judged result in step S32 is YES, the control method 2 performs step S34 to judge if the at least on touch position matches an OSD close command. If the judged result in step S34 is YES, the control method 2 performs step S42 to generate the OSD close command and execute the OSD close command to close the OSD function.

If the judged result in step S34 is NO, the control method 2 performs step S36 to judge if the at least one touch position locates within a region of the touch screen, where the region corresponds to an OSD menu displayed on the display screen relative to the opened OSD function. If the judged result in step S36 is YES, the control method 2 performs step S42 to generate an OSD instruction according to the at least one touch position and execute the OSD instruction.

If the judged result in step S36 is NO, the control method 2 performs step S38 to execute further procedures by the processor.

If the judged result in step S32 is NO, the control method 2 performs step S40 to judge if the at least one touch position matches an OSD open command. If the judged result in step S40 is YES, the control method 2 performs step S42 to generate the OSD open command and execute the OSD open command to open the OSD function.

If the judged result in step S40 is NO, the control method 2 performs step S38 to execute further procedures by the processor.

As to another way of process of the control method 2 according to the third preferred embodiment of the invention, the control method 2 judges whether the at least one touch position locates within the region first, and if YES, generates the OSD instruction according to the at least one touch position and executes the OSD instruction. If the control method 2 judges the at least one touch position does not locate within the region, then the control method 2 judges whether the at least one touch position matches an OSD close command, and if YES, generates the OSD close command and executes the OSD close command to close the OSD menu 102.

In summary, it is clear that the touch screen display with OSD function and control method for controlling OSD function of the touch screen display according to the invention can eliminate buttons, knobs or touch-sensing components and related controlling components, and can naturally resolve the problems caused by using buttons, knobs or touch-sensing components to control the OSD function. The touch screen display with OSD function and control method for controlling OSD function of the touch screen display according to the invention also helps to improve the appearance design of the display, and applies to thin and small displays.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A touch screen display, comprising:
an on-screen display (OSD) controller, for generating an OSD menu;
a display screen;
a processor, electrically connected to the OSD controller and the display screen respectively, for receiving the OSD menu from the OSD controller, and outputting the OSD menu to the display screen to display the OSD menu on the display screen;
a touch screen, installed on the display screen, the touch screen thereon having a region corresponding to the OSD menu displayed on the display screen; and
a touch controller, electrically connected to the touch screen and the processor respectively, for receiving at least one signal generated by the touch screen on that the at least one signal is generated in response to at least one external force imposed, and interpreting the at least one signal into at least one touch position relative to the at least one external force, wherein the processor receives the at least one touch position, judges whether the at least one touch position matches an OSD close command, and if YES, generates the OSD close command and transmits the OSD close command to the OSD controller to close the OSD menu.

2. The touch screen display of claim 1, wherein if the processor judges that the at least one touch position does not match the OSD close command, the processor judges whether the at least one touch position locates within the region, and if YES, generates an OSD instruction according to the at least one touch position and transmits the OSD instruction to the OSD controller.

3. A touch screen display, comprising:
an on-screen display (OSD) controller, for generating an OSD menu;
a display screen;
a processor, electrically connected to the OSD controller and the display screen respectively, for receiving the OSD menu from the OSD controller, and outputting the OSD menu to the display screen to display the OSD menu on the display screen;
a touch screen, installed on the display screen, the touch screen thereon having a region corresponding to the OSD menu displayed on the display screen; and
a touch controller, electrically connected to the touch screen and the processor respectively, for receiving at least one signal generated by the touch screen on that the at least one signal is generated in response to at least one external force imposed, and interpreting the at least one signal into at least one touch position relative to the at least one external force, wherein the OSD controller receives the at least one touch position, judges whether the at least one touch position matches an OSD close command, and if YES, generates the OSD close command to close the OSD menu.

4. The touch screen display of claim 3, wherein if the OSD controller judges that the at least one touch position does not match the OSD close command, the OSD controller judges whether the at least one touch position locates within the region, and if YES, generates an OSD instruction according to the at least one touch position.

5. A control method for controlling an on-screen display (OSD) function of a touch screen display, said touch screen display comprising a touch screen and a display screen, said method comprising the steps of:
(a) generating at least one signal in response to at least one external force imposed on the touch screen;
(b) interpreting the at least one signal into at least one touch position relative to the at least one external force;
(c) judging if the OSD function is turned on; and
(d) if YES in step (c), judging if the at least one touch position matches an OSD close command, and if YES, generating the OSD close command to close the OSD function.

6. The control method of claim 5, if NO in step (d), further comprising the steps of:
(e) judging if the at least one touch position locates within a region on the touch screen, wherein the region corresponds to an OSD menu displayed on the display screen and relative to the turned-on OSD function; and
(f) if YES in step (e), generating an OSD instruction according to the at least one touch position.

7. The control method of claim 5, if NO in step (c), further comprising the step of:
(g) judging if the at least one touch position matches an OSD open command, and if YES, generating the OSD open command to open the OSD function.

8. A touch screen display, comprising:
an on-screen display (OSD) controller, for generating an OSD menu;
a display screen;
a processor, electrically connected to the OSD controller and the display screen respectively, for receiving the OSD menu from the OSD controller, and outputting the OSD menu to the display screen to display the OSD menu on the display screen;
a touch screen, installed on the display screen, the touch screen thereon having a region corresponding to the OSD menu displayed on the display screen; and
a touch controller, electrically connected to the touch screen and the processor respectively, for receiving at least one signal generated by the touch screen on that the at least one signal is generated in response to at least one external force imposed, and interpreting the at least one signal into at least one touch position relative to the at least one external force, wherein the processor receives the at least one touch position, judges whether the at least one touch position locates within the region, and if YES, generates an OSD instruction according to the at least one touch position and transmits the OSD instruction to the OSD controller.

9. The touch screen display of claim 8, wherein if the processor judges that the at least one touch position does not locate within the region, the processor judges whether the at least one touch position matches an OSD close command, and if YES, generates the OSD close command and transmits the OSD close command to the OSD controller to close the OSD menu.

10. A touch screen display, comprising:
an on-screen display (OSD) controller, for generating an OSD menu;
a display screen;
a processor, electrically connected to the OSD controller and the display screen respectively, for receiving the OSD menu from the OSD controller, and outputting the OSD menu to the display screen to display the OSD menu on the display screen;
a touch screen, installed on the display screen, the touch screen thereon having a region corresponding to the OSD menu displayed on the display screen; and
a touch controller, electrically connected to the touch screen and the processor respectively, for receiving at least one signal generated by the touch screen on that the at least one signal is generated in response to at least one external force imposed, and interpreting the at least one signal into at least one touch position relative to the at least one external force, wherein the OSD controller receives the at least one touch position, judges whether the at least one touch position locates within the region, and if YES, generates an OSD instruction according to the at least one touch position.

11. The touch screen display of claim 10, wherein if the OSD controller judges that the at least one touch position does not locate within the region, the OSD controller judges whether the at least one touch position matches an OSD close command, and if YES, generates the OSD close command to close the OSD menu.

12. A control method for controlling an on-screen display (OSD) function of a touch screen display, said touch screen display comprising a touch screen and a display screen, said method comprising the steps of:
(a) generating at least one signal in response to at least one external force imposed on the touch screen;
(b) interpreting the at least one signal into at least one touch position relative to the at least one external force;
(c) judging if the OSD function is turned on; and
(d) if YES in step (c), judging if the at least one touch position locates within a region on the touch screen, and if YES, generating an OSD instruction according to the at least one touch position, wherein the region corresponds to an OSD menu displayed on the display screen and relative to the turned-on OSD function.

13. The control method of claim 12, if NO in step (d), further comprising the steps of:
(e) judging if the at least one touch position matches an OSD close command; and
(f) if YES in step (e), generating the OSD close command to close the OSD function.

14. The control method of claim 12, if NO in step (c), further comprising the step of:
(g) judging if the at least one touch position matches an OSD open command, and if YES, generating the OSD open command to open the OSD function.
